(19) United States
(12) Patent Application Publication
(10) Pub. No.: US 2006/0061003 A1
(43) Pub. Date: Mar. 23, 2006

(54) Method for producing a thermoplastic resin foamed article

(75) Inventors: Satoshi Hanada, Ichihara-shi (JP); Yoshinori Ohmura, Osaka (JP)

Correspondence Address: FITCH, EVEN, TABIN & FLANNERY, P. O. BOX 65973, WASHINGTON, DC, 20035, US

(73) Assignees: Sumitomo Chemical Company, Limited, Tokyo (JP); Sumika Plastech Co., Ltd., Tokyo (JP)

(21) Appl. No.: 11/225,086

(22) Filed: Sep. 14, 2005

(30) Foreign Application Priority Data
Sep. 17, 2004 (JP) 2004-271233

(51) Int. Cl. B29C 44/00

(52) U.S. Cl. 264/46.8

(57) ABSTRACT

Disclosed is a method for producing a thermoplastic resin foamed article using an apparatus including a pair of molds each having a molding surface through which vacuum sucking can be conducted, the method comprising a step of, while holding a foamed sheet between the molds, vacuum sucking through the molding surfaces of the molds to shape the thermoplastic resin foamed sheet, wherein the foamed sheet to be subjected to vacuum forming having a first foamed layer having an expansion ratio Xa of from 2 to 20, a thickness Ta of from 2 to 20 mm and a basis weight Ra of from 600 to 3000 g/m² and a second foamed layer having an expansion ratio Xb of from 4 to 40, a thickness Tb of from 2 to 12 mm and a basis weight Rb of from 100 to 600 g/m² wherein Ra/Rb is from 2 to 30.

### BACKGROUND OF THE INVENTION

1. Field of the Invention

The present invention relates to a method for producing a thermoplastic resin foamed article by vacuum forming.

2. Description of the Related Art

Thermoplastic resin foamed articles are superior in lightweight property, recyclability, heat insulation property, etc. and, therefore, are used for various applications such as automotive component materials, building or construction materials and packaging materials.

When thermoplastic resin foamed articles are used for applications such as those mentioned above, they are often required to have cushioning property and rigidity. For example, Japanese Patent Application Publication No. 8-174737 discloses a laminated polypropylene resin foamed sheet having a thickness of 3 to 5 mm in which a foamed sheet with a low density has been laminated on one side of a foamed sheet with a high density.

Since the laminated polypropylene resin foamed sheet is as thin as 5 mm or less, foamed articles produced by secondary molding of the laminated polypropylene resin foamed sheet are thin and may be of insufficient cushioning property or rigidity.

### SUMMARY OF THE INVENTION

In one aspect, the present invention provides a method for producing a thermoplastic resin foamed article by vacuum forming using a molding apparatus including a pair of molds each having a molding surface through which vacuum sucking can be conducted, the method comprising a step of, while holding a thermoplastic resin foamed sheet between the molds, vacuum sucking through the molding surfaces of the molds to shape the thermoplastic resin foamed sheet, wherein the thermoplastic resin foamed sheet to be subjected to vacuum forming having a first foamed layer having an expansion ratio Xa of from 2 to 20, a thickness Ta of from 2 to 20 mm and a basis weight Ra of from 600 to 3000 g/m² and a second foamed layer having an expansion ratio Xb of from 4 to 40, a thickness Tb of from 2 to 12 mm and a basis weight Rb of from 100 to 600 g/m² wherein Ra/Rb is from 2 to 30.

According to the method for vacuum forming of a thermoplastic resin foamed sheet of the present invention, it is possible to produce thermoplastic resin foamed articles which are superior in both cushioning property and rigidity and have large thicknesses.

### BRIEF DESCRIPTION OF THE DRAWINGS

In the drawings,

FIG. 1 is a diagram which shows one example of the apparatus for producing a second thermoplastic resin foamed sheet,

FIG. 2 is a diagram which shows one example of the cross-sectional shape of the circular die for use in the production of a second thermoplastic resin foamed sheet,

FIG. 3 is a schematic diagram showing one embodiment of the methods of the present invention for producing a thermoplastic resin foamed sheet, and

FIG. 4 is a schematic diagram showing one embodiment of the methods of the present invention for producing a thermoplastic resin foamed sheet.

The signs in the drawings have meanings shown below: 1: apparatus for producing a second thermoplastic resin foamed sheet; 2: 50 mmφ twin screw extruder; 3: 32 mmφ single screw extruder; 4: circular die; 5: pump for supplying carbon dioxide gas; 6: mandrel; 7: head of 50 mmφ twin screw extruder; 8: head of 32 mmφ single screw extruder; 9a, 9b, 10a, 10b, 10c, 10d, 11a, 11b: passageway; 12: outlet of a circular die; 13: thermoplastic resin foamed sheet; 14: clip; 15: infrared heater; 16, 17: mold.

### DESCRIPTION OF THE PREFERRED EMBODIMENTS

The thermoplastic resin foamed sheet to be subjected to vacuum forming in the present invention has a first foamed layer having an expansion ratio Xa of from 2 to 20, a thickness Ta of from 2 to 20 mm and a basis weight Ra of from 600 to 3000 g/m² and a second foamed layer having an expansion ratio Xb of from 4 to 40, a thickness Tb of from 2 to 12 mm and a basis weight Rb of from 100 to 600 g/m² wherein Ra/Rb is from 2 to 30. When vacuum forming is effected by a method described later using such a thermoplastic resin foamed sheet, the second foamed layer is expanded more than the first foamed layer. Therefore, it is possible to afford rigidity by the first foamed layer and cushioning property by the second layer. Thus, articles with excellent rigidity and cushioning property are provided.

The thermoplastic resin foamed sheet may have a non-foamed layer in addition to the first and second foamed layers.

Examples of the resin for forming the thermoplastic resin foamed sheet include olefin-based resin such as homopolymers of olefins having 6 or less carbon atoms e.g. ethylene, propylene, butene, pentene and hexene, olefin copolymers produced by copolymerizing two or more kinds of monomer selected from olefins having form 2 to 10 carbon atoms, ethylene-vinyl ester copolymers, ethylene-(meth)acrylic acid copolymers, ethylene-(meth)acrylic ester copolymers, ester resin, amide resin, styrenic resin, acrylic resin, acrylonitrile-based resin and ionomer resin. These resins may be used either solely or in the form of blend of two or more resins. Among these resins, olefin-based resins are preferably used from the viewpoints of moldability, oil resistance and cost. Propylene-based resins are particularly preferably used from the viewpoint of rigidity and heat resistance of resulting molded articles.

When a foamed sheet made of a propylene-based resin is used, examples of the propylene-based resin forming a foamed layer include propylene homopolymers and propylene-based copolymers including at least 50 mol % of propylene units. The copolymers may be block copolymers, random copolymers or graft copolymers. Examples of the propylene-based copolymers to be suitably employed include copolymers of propylene with ethylene or an α-olefin having 4 to 10 carbon atoms. Examples of the α-olefin having 4 to 10 carbon atoms include 1-butene, 4-methylpentene-1,1-hexene and 1-octene. The content of the monomer units except propylene units in the propylene-based copolymer is preferably up to 15 mol % for ethylene and up to 30 mol % for α-olefins having 4 to 10 carbon atoms. A single kind of propylene-based resin may be used. Alternatively, two or more kinds of propylene-based resin may also be used in combination.

When a long-chain-branching propylene-based resin or a propylene-based resin having a weight average molecular weight of 1×10⁵ or more is used in an amount of 50% by weight or more of the thermoplastic resin forming the foamed layer, it is possible to produce a propylene-based resin foamed sheet containing finer cells. Among such propylene-based resins, non-crosslinked propylene-based resins are preferably used because less gel is formed during a process of recycling the foamed sheets.

By the “long-chain-branching propylene-based resin” used herein is meant a propylene-based resin whose branching index [A] satisfies 0.20≦[A]≦0.98. One example of the long-chain-branching propylene-based resins having a branching index [A] satisfying 0.20≦[A]≦0.98 is Propylene PF-814 manufactured by Basell Co.

The branching index quantifies the degree of long chain branching in a polymer and is defined by the following formula.
Branching index [A]=[η]_{Br}/[η]_{Lin}
In the formula, [η]_{Br} is the intrinsic viscosity of the long-chain-branching propylene-based resin. [η]_{Lin} is the intrinsic viscosity of a linear propylene-based resin made up of monomer units the same as those of the long-chain-branching propylene-based resin and having a weight average molecular weight the same as that of the long-chain-branching propylene-based resin.

The intrinsic viscosity, which is also called a limiting viscosity number, is a measure of the capacity of a polymer to enhance the viscosity of its solution. The intrinsic viscosity depends especially on the molecular weight and on the degree of branching of the polymer molecule. Therefore, the ratio of the intrinsic viscosity of the long-chain-branching polymer to the intrinsic viscosity of a linear polymer having a molecular weight equal to that of the long-chain-branching polymer can be used as a measure of the degree of branching of the long-chain-branching polymer. The intrinsic viscosity of a propylene-based resin can be determined by a conventionally known method such as that described by Elliott et al., J. Appl. Polym. Sci., 14, 2947-2963 (1970). For example, the intrinsic viscosity can be measured at 135° C. by dissolving the propylene-based resin in tetralin or orthodichlorobenzene.

The weight average molecular weight (Mw) of a propylene-based resin may be determined by various methods commonly used. Particularly preferably employed is the method reported by M. L. McConnel et al. in American Laboratory, May, 63-75 (1978), namely, the low-angle laser light-scattering intensity measuring method.

One example of the method for producing a high-molecular-weight propylene-based resin having a weight average molecular weight of 1×10⁵ or more by polymerization is a method in which a high molecular weight component is produced first and then a low molecular weight component is produced as described in Japanese Patent Application Publication No. 11-228629.

Among the long-chain-branching propylene-based resin and the high-molecular-weight propylene-based resin, preferred is a propylene-based resin having a uniaxial melt elongation viscosity ratio η₅/η_{0.1} of 5 or more, more preferably 10 or more, measured under the conditions given below at about a temperature 30° C. higher than the melting point of the resin. The uniaxial melt elongation viscosity ratio is a value measured at an elongation strain rate of 1 sec⁻¹ using a uniaxial elongation viscosity analyzer (for example, a uniaxial elongation viscosity analyzer manufactured by Rheometrix), wherein η_{0.1} denotes a uniaxial melt elongation viscosity detected 0.1 second after the start of strain and η₅ denotes a uniaxial melt elongation viscosity detected 5 seconds after the start of strain.

As the foaming agent for use in the preparation of the foamed sheet, either of the chemical foaming agent or the physical foaming agent may be used. Moreover, both types of foaming agents may be used together. Examples of the chemical foaming agent include known thermally decomposable compounds such as thermally decomposable foaming agents which form nitrogen gas through their decomposition (e.g., azodicarbonamide, azobisisobutyronitrile, dinitrosopentamethylenetetramine, p-toluenesulfonyl hydrazide, p,p′-oxy-bis(benzenesulphonyl hydrazide); and thermally decomposable inorganic foaming agents (e.g., sodium hydrogencarbonate, ammonium carbonate and ammonium hydrogencarbonate). Specific examples of the physical foaming agent include propane, butane, water and carbon dioxide gas. Among the foaming agents provided above as examples, water and carbon dioxide gas are suitably employed because foamed sheets produce less deformation caused by secondary foaming during heating in vacuum forming and also because those agents are substances inert at high temperatures and inert to fire. The amount of the foaming agent used is appropriately determined on the basis of the kinds of the foaming agent and resin used so that a desired expansion ratio is achieved. However, 0.5 to 20 parts by weight of foaming agent is normally used for 100 parts by weight of thermoplastic resin.

The method for producing the thermoplastic resin foamed sheet for use in the present invention is not restricted and a thermoplastic resin foamed sheet having the first foamed layer and the second foamed sheet may be produced by extrusion forming using a flat die (T die) or a circular die. Alternatively, the first foamed layer and the second foamed layer may be laminated by dry lamination, sandwich lamination, hot roll lamination, hot air lamination or the like.

The thermoplastic resin foamed sheet may have a layer made of resin or rubber such as thermoplastic resin, thermosetting resin and thermoplastic elastomer, natural fiber such as hemp, jute and the like, minerals such as calcium silicate, synthetic paper, thin plate or foil of metal such as aluminum and iron.

Thermoplastic resin foamed sheets for use in the present invention may include additives. Examples of the additives include filler, antioxidants, light stabilizers, ultraviolet absorbers, plasticizers, antistatic agents, colorants, release agents, fluidizing agents and lubricants. Specific examples of the filler include inorganic fibers such as glass fiber and carbon fiber and inorganic particles such as talc, clay, silica, titanium oxide, calcium carbonate and magnesium sulfate.

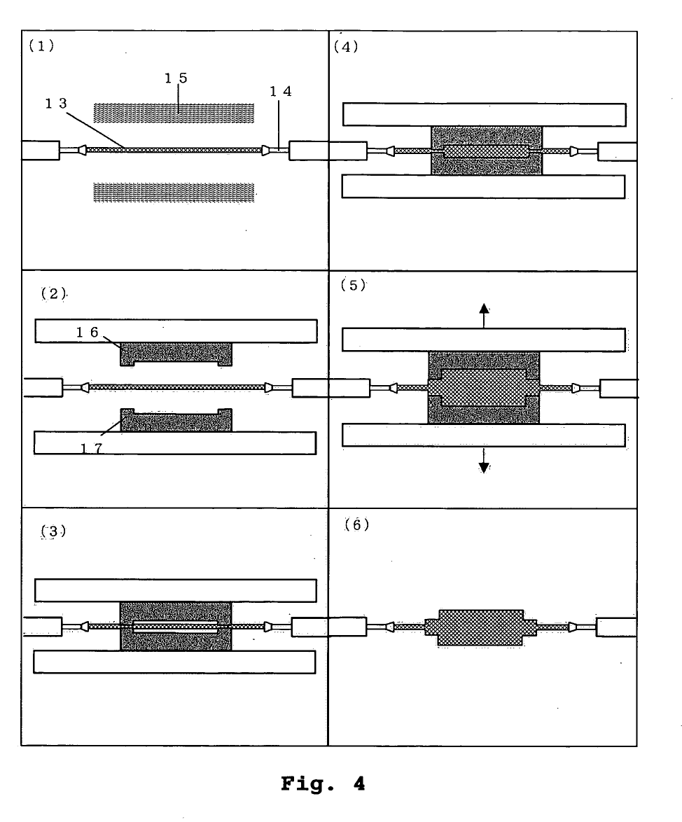

The method of the present invention is a method in which a thermoplastic resin foamed sheet such as that mentioned above is subjected to vacuum forming by using a pair of molds each having a molding surface through which vacuum sucking can be conducted and vacuum sucking through the molding surfaces of the molds. One example of the method is described in detail below with reference to FIG. 3, but the present invention is not limited to this example.

In the present invention, used is a pair of opposing molds each having a molding surface through which vacuum sucking can be conducted. Examples of the paired molds include a pair of one male mold and one female mold, a pair of two female molds, and a pair of two flat molds.

Examples of the molds having a molding surface through which vacuum sucking can be conducted include molds each having a molding surface at least part of which is composed of sintered alloy and molds each having a molding surface provided, at least in its restricted section, with one or more holes through which the air is exhausted. The number, location and diameter of the hole or holes with which the molds are provided are not particularly limited if a thermoplastic resin foamed sheet supplied between the molds can be shaped into the shape of the molding surface of the mold.

The molds have no particular limitations on their material, but from the viewpoints of dimensional stability, durability and thermal conductivity, they are typically made of metal. From the viewpoints of cost and weight, the molds are preferably made of aluminum.

The molds are preferably structured so that the temperature thereof can be controlled by a heater or heat medium. For improving the lubricity of a foamed sheet or preventing a foamed sheet from cooling before completion of its molding, the temperatures of the molding surfaces of the molds are preferably adjusted within a range of from 30 to 80° C., more preferably from 50 to 60° C.

It is desirable that at least one mold be a mold having an air tightness holding function. Use of such a mold makes it easy to maintain the degree of vacuum in the cavity when vacuum sucking and makes it possible to produce molded articles with extremely less shrinkage. One example of the mold having the air tightness holding function is a mold in which the peripheral portion of its molding surface can move toward the opposing mold. Such a mold preferably has a structure such that the movable portion can be collapsed in the mold so that the top face of the movable portion comes in the same level as the molding surface at the time of mold closure. Use of such a mold makes it easy to maintain the degree of vacuum in the cavity in a mold opening step which is mentioned later because the mold is structured so that the movable portion protrudes as the mold is opened.

Another example of the mold having the air tightness holding function is a mold having a cushioning material on the peripheral portion of the molding surface. Foamed sheets normally have fine unevenness on their surfaces. When a mold having a cushioning material is used, it is easy to maintain the degree of vacuum in the cavity when vacuum sucking is carried out because the cushioning material will come into intimate contact with a finely uneven surface of a foamed sheet through mold closure. The cushioning material may be rubber, foam and the like.

A pair of molds are also available wherein one mold is covered with an air tightness holding section provided on the periphery of the other mold when the molds are closed.

Molds may have means for fixing a foamed sheet on their molding surfaces and/or peripheral portions of the molding surfaces. Examples of such means include adhesive, pins, hooks, clips and slits. Use of a mold having such means for fixing a foamed sheet makes it easy to shape a foamed sheet into the shape of the molding surface.

Regarding the molding apparatus, it is desirable to use a molding apparatus such that the molding surfaces of both molds will define therebetween a cavity with a height as high as 0.8 to 2 times the thickness of the foamed sheet softened in step (1) at the completion of mold closure. The height of a cavity referred to herein means the distance between the molding surfaces corresponding to the thickness direction of the foamed sheet supplied between the molds. The cavity is not required to have the same height at all places in the cavity. The cavity may be any one having a shape corresponding to the shape of a desired molded article. If the height of the cavity defined at completion of mold closure is too small, cells in the foamed sheet may be broken. If it is too large, it becomes difficult to shape the foamed sheet by bringing the surfaces of the foamed sheet into contact with the molding surfaces of the molds even if vacuum sucking is carried out. Even if the foamed sheet is brought into contact with the molding surfaces, the foamed sheet becomes susceptible to burst of cells.

FIG. 3-(1) shows step (1) of heating a thermoplastic resin foamed sheet to soften it. In step (1), the foamed sheet is usually held in a clamp frame and heated by a heating device such as a far infrared heater, a near infrared heater, a contact type hot plate. A far infrared heater is preferably used because it can heat the foamed sheet efficiently in a short time. It is desirable to heat the foamed sheet so that the foamed sheet comes to have a surface temperature near a melting point of the resin forming the foamed sheet when the resin is a crystalline resin or near a glass transition temperature of the resin when the resin is a non-crystalline resin.

FIG. 3-(2) shows a state where, in step (2), a thermoplastic resin foamed sheet softened in step (1) has been supplied between a pair of molds each having a molding surface through which vacuum sucking can be conducted.

FIG. 3-(3) shows a step of closing the molds, in step (3), until a clearance between peripheral portions of the molding surfaces of the molds arrives at a predetermined value not greater than the thickness of the softened thermoplastic resin foamed sheet while holding the softened thermoplastic resin foamed sheet with holding means between the molds. Mold closure is carried out so that the opposing molding surfaces of the molds relatively approach to each other. For example, one mold is fixed and the other is moved toward the fixed one. Alternatively, both molds are moved in opposite directions so that the molds approach to each other.

FIG. 3-(4) shows a state where vacuum sucking is carried out through the molding surfaces of the molds. In step (4), the vacuum sucking may be started at any point of time during a period from the arrival of the clearance between the peripheral portions of the molding surfaces at the thickness of the softened thermoplastic resin foamed sheet to the arrival of the clearance at a predetermined value not greater than the foamed sheet. For example, it is permissive that vacuum sucking is started at a time when the clearance between the peripheral portions of the molding surfaces becomes equal to the thickness of the softened thermoplastic resin foamed sheet and the molds are further closed to a predetermined thickness smaller than the thickness of the foamed sheet while continuing the vacuum sucking. Alternatively, it is also permissive that vacuum sucking is started at the same time or after the clearance becomes a predetermined thickness not greater than the thickness of the softened thermoplastic resin foamed sheet. When the vacuum sucking is carried out after the foamed sheet comes to have a predetermined thickness, it is usually desirable to start the vacuum sucking before the foamed sheet is cooled and within three seconds from the time when the foamed sheet comes to have the predetermined thickness.

For obtaining a molded article having a uniform internal structure, it is desirable to start vacuum sucking through one mold and vacuum sucking through the other mold simultaneously. However, it is permissive to make a time difference between the starts of vacuum sucking unless the foamed sheet is cooled. When vacuum sucking through one mold is started after the start of vacuum sucking through the other mold, the time difference between the starts of vacuum sucking is preferably within three seconds.

The degree of vacuum sucking is not particularly limited, but it is desirable to suck so that the degree of vacuum in the cavity becomes from −0.05 MPa to −0.1 MPa. The degree of vacuum is a pressure in the cavity with respect to atmospheric pressure. For example, “the degree of vacuum is −0.05 MPa” means that the pressure in the cavity is lower than atmospheric pressure by 0.05 MPa. The higher the degree of vacuum, the more strongly a foamed sheet is attracted to a mold. It, therefore, becomes possible to shape a foamed sheet into a shape closer to the shape of the cavity. The degree of vacuum of a cavity is a value measured at an opening, provided in the cavity, of a hole through which vacuum sucking is conducted.

As shown in FIG. 3-(4), in step (5), the sheet is shaped into a shape defined by the molding surfaces of the molds while the vacuum sucking is continued.

In step (6), the foamed sheet is fully cooled. Then, the vacuum sucking is stopped and the molds are further opened. Finally, a resulting molded article is removed. FIG. 3-(5) shows a state where the molds (not shown) have been opened for the removal of the molded article.

As a method for obtaining a thermoplastic resin foamed article which is superior in cushioning property and rigidity and has a large thickness, preferred is to effect an operation of opening the molds until the thermoplastic resin foamed sheet comes to have a predetermined thickness greater than the thickness of the softened thermoplastic resin foamed sheet at the beginning of step (3) during the step (5) of shaping the sheet into a shape defined by the molding surfaces of the molds while continuing the vacuum sucking.

FIG. 4 is a schematic diagram showing the embodiment including the mold opening for shaping. FIGS. 4-(1) to (4) and (6) are the same as FIGS. 3-(1) to (5). FIG. 4-(5) shows a state where while the vacuum sucking is continued, the molds have been opened until the thermoplastic resin foamed sheet has come to have a predetermined thickness greater than the thickness of the softened thermoplastic resin foamed sheet at the beginning of step (3). The opening of the molds is carried out while the vacuum sucking is continued. The speed of mold opening and the degree of vacuum during the mold opening may be adjusted so that the foamed sheet is successfully shaped into the shape of a desired molded article.

In the present invention, a skin material may be placed on the molding surface of one or each mold before the softened foamed sheet is supplied between the molds. The skin material is not particularly restricted with respect to its material and thickness if a foamed sheet can be shaped into the shape of a molding surface by vacuum suction through the skin material. Examples of raw material of the skin material include resin such as thermoplastic resin and thermosetting resin, rubber such as thermoplastic elastomer, natural fiber such as hemp, jute and the like, minerals such as calcium silicate. Examples of the form of the skin material include film, sheet, non-woven fabric and woven fabric. In addition to the materials mentioned above, synthetic paper made of propylene-based resin or styrene-based resin and thin plate or foil of metal such as aluminum and iron may also be used. The skin material may be composed of either one layer or two or more layers. The skin material may have been provided with decoration such as uneven pattern e.g. grain pattern, print and dyeing.

Molded articles produced by the methods of the present invention can be used as packaging materials such as food containers, automotive interior components, building or construction materials and household electrical appliances because they are superior in cushioning property and rigidity and have large thicknesses. Examples of the automotive interior components include door trims, ceilings and trunk side panels. When molded articles produced according to the present invention are used as such components, it is possible to maintain the temperature inside a car for a long time after the temperature is adjusted. In the case of producing automotive interior components by a method of the present invention, it is desirable to produce an article which has been laminated on its surface with a layer made of sheet or non-woven fabric of thermoplastic resin or a layer of natural fiber such as woolen fabrics, hemp and jute. Molded articles produced by a method of the present invention for use as food containers may have various shapes such as cup, tray and bowl. Since they are superior in heat insulation property, they can be preferably used as containers for soup heated to high temperatures and food containers for cooking in a microwave oven. When producing a molded article as a food container by the method of the present invention, it is desirable to produce articles which have been laminated on its surface with a unilayer or multilayer gas barrier film having an ethylene-vinyl alcohol copolymer layer or a CPP film.

### EXAMPLES

The present invention is explained with reference to Examples below. The invention, however, is not limited to the Examples.

### Example 1

(Production of a First Thermoplastic Resin Foamed Sheet)

(Material for Forming a Foamed Layer)

0.1 Part by weight of calcium stearate, 0.05 part by weight of phenol-type antioxidant (commercial name: Irganox 1010, manufactured by Ciba Specialty Chemicals, Inc.) and 0.2 part by weight of phenol-type antioxidant (commercial name: Sumilizer BHT, manufactured by Sumitomo Chemical Co., Ltd.) were added to and mixed with 100 parts by weight of a propylene-based polymer powder which was prepared by the method described in Japanese Patent Application Publication No. 11-228629 and which had physical properties shown below. The mixture was melt-kneaded at 230° C. Thus, propylene-based polymer pellets (i) were produced. The melt flow rate (MFR), measured at 230° C. under a load of 2.16 kgf in accordance with JIS K6758, of the propylene-based polymer pellets (i) was 12 g/10 min. The propylene-based polymer pellets (i) were used as a material for forming a foamed layer.

Physical Properties of the Propylene-Based Polymer:

Component (A) (the component having a higher molecular weight of the two components contained in the propylene-based polymer obtained by the method disclosed in Japanese Patent Application Publication No. 11-228629):

intrinsic viscosity [η]A=8 dl/g;

content of ethylene-derived units (C2 in A)=0%;

Component (B) (the component having a lower molecular weight of the two components contained in the propylene-based polymer obtained by the method disclosed in Japanese Patent Application Publication No. 11-228629):

intrinsic viscosity [η]B=1.2 dl/g;

content of ethylene-derived (C2 in B)=0%.

Propylene-Based Polymer Composed of Components (A) and (B):

η₅=71,000 Pa·s and η_{0.1}=2,400 Pa·s, measured using a uniaxial elongation viscosity analyzer manufactured by Rheometrics Co. at a temperature of 180° C. and an elongation strain rate of 0.1 sec⁻¹.

A material for forming a foamed layer is prepared by blending the propylene-based polymer pellets (i), polypropylene (ii) (Polypropylene AW191 manufactured by Sumitomo Chemical Co., Ltd., MFR 11 g/10 min (at 230° C., 2.16 kgf load)) and polyethylene (iii) (Polyethylene CX3502 manufactured by Sumitomo Chemical Co., Ltd., MFR 4 g/10 min (at 190° C., 2.16 kgf load)) in a weight ratio (i)/(ii)/(iii)=70/15/15. A mixture prepared by blending 1.4 parts by weight of a foaming agent composed of azodicarbonamide, sodium hydrogencarbonate and zinc oxide in a weight ratio of 5/90/5 with 100 parts by weight of the material for forming a foamed layer was fed to a foamed sheet manufacturing machine.

The machine included a 120 mmφ single screw extruder equipped, at one end the extruder, with a gear pump. The extruder was also equipped with a monolayer T-die of single manifold type having an outlet passage width of 1500 mm and adjusted to 180° C. The material for forming a foamed layer fed to the foamed sheet manufacturing machine was extruded through the T-die at a rate of 160 kg/hr and was shaped into a smooth foamed sheet over a cooling molding machine including a take-off roll with a diameter of 300 mm controlled to 60° C. The foamed sheet was trimmed to have a width of 500 mm by means of an edge trimming device mounted at a downstream section of the cooling molding machine. Then, the trimmed sheet was taken off with a haul-off unit. Thus, a first thermoplastic resin foamed sheet having an expansion ratio of 3, a thickness of 3 mm, a width of 500 mm and a basis weight of 900 g/m² was obtained.

Aside from the first thermoplastic resin foamed sheet, a two-kind three-layer second thermoplastic resin foamed sheet composed of a foamed layer having on each side a non-foam layer laminated was produced by a method described below.

(Material for Forming a Foamed Layer)

Propylene polymer pellets (i) the same as those used as the material for forming a foamed layer of the first thermoplastic resin foamed sheet were used as a material for forming a foamed layer.

(Material for Forming Non-Foamed Layer)

Polypropylene (iv) (homopolypropylene FS2011DG2 manufactured by Sumitomo Chemical Co., Ltd., MFR: 2.5 g/10 min (at 230° C., 2.16 kgf load)), polypropylene (v) (long-chain-branching homopolypropylene named PF814 manufactured by Basell, MFR: 3 g/10 min (at 230° C., 2.16 kgf load)), polypropylene (vi) (propylene-ethylene random copolymer W151 manufactured by Sumitomo Chemical Co., Ltd., ethylene-derived structural unit content: 4.5% by weight, MFR: 8 g/10 min (at 230° C., 2.16 kgf load)), talc masterbatch (vii) (block polypropylene-based talc masterbatch MF110 manufactured by Sumitomo Chemical Co., Ltd., talc content: 70 wt %), and titanium masterbatch (viii) (titanium masterbatch PPM2924 manufactured by Tokyo Ink Co., Ltd., titanium content: 60 wt %, MFR of random polypropylene base: 30 g/10 min (at 230° C., 2.16 kgf load)) were dry-blended in weight proportions of (iv)/(v)/(vi)/(vii)/(viii)=12/30/15/43/5 to yield a material for forming a non-foamed layer.

(Production of a Second Thermoplastic Resin Foamed Sheet)

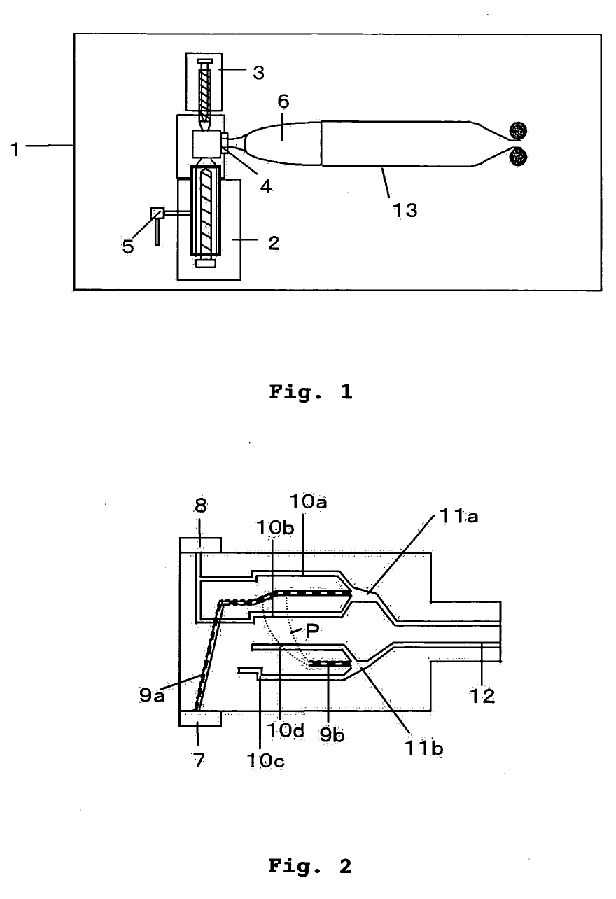

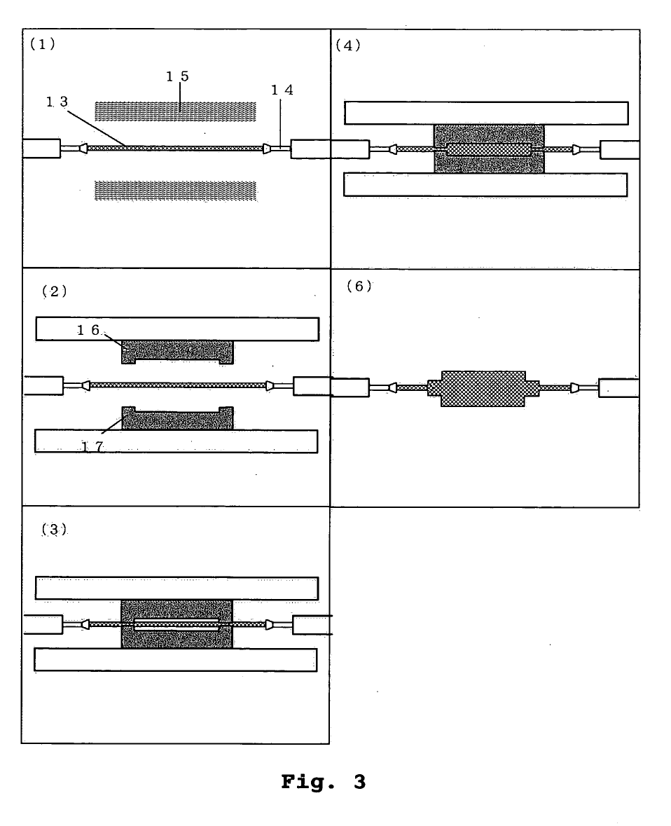

Using the materials for forming a foamed layer and a non-foamed layer described above, extrusion forming was carried out by means of an apparatus (1), shown in FIGS. 1 and 2, in which a 50 mmφ twin screw extruder (2) for extruding a foamed layer and a 32 mmφ single screw extruder (3) for extruding a non-foamed layer were connected to a 90 mmφ circular die (4). A second thermoplastic resin foamed sheet was produced in the following manner.

A material prepared by blending 0.1 part by weight of a nucleating agent (MB1023 manufactured by Sankyo Chemical Co., Ltd.) to 100 parts by weight of the material for forming a foamed layer was supplied to the 50 mmφ twin screw extruder (2) through a hopper and kneaded in a cylinder heated to 180° C.

When, in the 50 mmφ twin screw extruder (2), the material for forming a foamed layer and the nucleating agent were fully mixed together by melt kneading and the nucleating agent was thermally decomposed to foam, 1.3 parts by weight of carbon dioxide gas as a physical foaming agent was poured from a pump (5) connected to a liquefied carbon dioxide cylinder. After the pouring of carbon dioxide gas, the mixture was further kneaded so that the resinous material was impregnated with carbon dioxide gas. Then, the resulting mixture was fed to the circular die (4). The material for forming a non-foamed layer was melt-kneaded in the 32 mmφ single screw extruder (3) and then fed to the circular die (4).

The material for forming a foamed layer was introduced into the circular die (4) through a head (7) of the 50 mmφ twin screw extruder and was conveyed toward the outlet of the die through a passageway (9a). On the midway in the passageway (9a), the material was divided through a path P and conveyed also into a passageway (9b).

The material for forming a non-foamed layer was introduced into the die through a head (8) of the 32 mmφ single screw extruder (3) and then divided into passageways (10a) and (10b). After the division, the material was transmitted toward the outlet of the die while being supplied so as to be laminated on both sides of the passageway (9a). At a point (11a), the lamination was achieved. The material for forming an on-foamed layer, which was supplied into the passageways (10a) and (10b), was divided and transmitted into passageways (10c) and (10d) through branching paths (not shown) similar to the path P. Then the material was transmitted toward the outlet of the die while being supplied so as to be laminated on both sides of the passageway (9b). At a point (11b), the lamination was achieved.

The molten resin fabricated into a tubular two-kind three-layer structure at (11a) and (11b) was extruded through the outlet (12) of the circular die (4). The release of the tubular resin to atmospheric pressure allowed the carbon dioxide gas contained in the material for forming a foamed layer to expand to form cells. Thus, a foamed layer was formed.

The two-kind three-layer foamed sheet extruded through the die was stretched and cooled while being drawn over a mandrel (6) having a maximum diameter of 700 mm to form a tube. The resulting tubular foamed sheet was cut along the longitudinal direction (MD) at two places to form two flat sheets 1080 mm wide. Each sheet was taken off on a take-off roll, followed by trimming at their lateral sides. Thus, a second thermoplastic resin foamed sheet with an expansion ratio of 5, a thickness of 1.5 mm, a width of 500 mm and a basis weight of 270 g/m² was obtained.

(Production of a Third Thermoplastic Resin Foamed Sheet)

Lamination of the first and second thermoplastic resin foamed sheets was carried out by a method described below using a pair of metal rolls each having a width of 500 mm and a diameter of 150 mm. The temperatures of the rolls were controlled by circulation of heated oil in the rolls.

The first thermoplastic resin foamed sheet was placed face-to-face on the second thermoplastic resin foamed sheet with the centers of their TD directions matched. Then, the sheets were pressed together through a pair of rolls rotating at a line speed of 0.5 m/min.

Specifically, an air knife was placed so that the air outlet thereof was kept apart by a distance of 75 mm from the pressing point of the rolls. Hot air was blown at a speed of 10 m/s so that the temperature at a point 10 mm apart from the air outlet became 210° C. While the facing surfaces of the first and second thermoplastic resin foamed sheets were heated with the hot air, the sheets were pressed with the rolls to laminate together. Thus, a third thermoplastic resin foamed sheet laminated was obtained. The clearance between the rolls was 4.3 mm and the roll pressure produced by compressed air was 3 kgf/cm².

The third thermoplastic resin foamed sheet obtained by the method described above was subjected to vacuum molding using a vacuum molding machine (VAIM0301 manufactured by Satoh Machinery Works, Co., Ltd.) as shown in FIG. 3. Both molds 16, 17 were female molds made of epoxy resin. Each mold had a molding surface composed of a square bottom surface sized 300 mm×300 mm and four side surfaces sized 300 mm×2 mm. Each mold had a parting face 15 mm wide along with the outer edge of the molding surface. Each mold had, at the four corners and on the four sides of the bottom surface of the molding surface, twelve, in total, vacuum sucking holes with a diameter of 1 mm at 10 cm intervals. The temperatures of the molds were adjusted to 60° C. during the molding.

The third thermoplastic resin foamed sheet (13) was fixed in a clamp frame (14) and then was heated with an infrared heater (15) so that the surface of the sheet reached 160° C. Thus, the sheet was softened. The softened sheet (13) had a thickness of 4.5 mm.

The sheet softened was supplied between the molds (16) and (17) while being fixed in the clamp frame.

The molds (16) and (17) were closed by being caused to approach to each other until the clearance between the parting faces of the molds became 4 mm. Concurrently with the completion of the mold closure, vacuum sucking at a degree of vacuum of −0.09 MPa through the molds was started and was continued for 10 seconds.

Subsequently, the vacuum sucking was stopped and the molds were opened. Finally, the molded article produced was removed. Results of evaluations of the molded article are shown in Table 1.

(Measurement of Expansion Ratio)

A product sampled in a size 20 mm×20 mm was measured for the specific gravity by means of an immersion-type densimeter (Automatic Densimeter, D-H100, manufactured by Toyo Seiki Seisaku-Sho Co., Ltd.) The expansion ratio was calculated on the basis of the densities of the materials forming the product.

(Flexural Rigidity)

A sheet for measurement was cut to have a width of 50 mm (in TD) and a length of 150 mm (in MD). The sample was set on a support table of an Autograph having a span adjusted to 100 mm (Model AGS-500D, manufactured by Shimadzu Corp.) so that the centers of the sample and the support table were matched. A rod-like jig having a head with a radius of curvature of 5 mm was applied to the center of the sample. While the sample was made deflect at a rate of 10 mm/min, a correlation curve between displacement (cm) and load (N) was produced. The initial slope (N/cm) was defined as the flexural rigidity of the sheet.

(Evaluation of Heat Transmission Coefficient)

A thermal conductivity was measured in accordance with JIS A-1412 using a thermal conductivity analyzer (AUTO-A series HC-074) manufactured by Eiko Seiki Co., Ltd. On the basis of the measurement, a heat transmission coefficient was calculated. The measurement conditions are as follows: low temperature plate temperature: 20° C., high temperature plate temperature: 30° C. The smaller the heat transmission coefficient, the better the heat insulation property.

(Cushioning Property)

The measurement was carried out in accordance with JIS K-6767. Square samples with sides of 50 mm were taken off from a sheet to be measured. Several pieces of the samples were stacked on a flat stage of an Autograph (Model AGS-500D, manufactured by Shimadzu Corp.) so that the foamed sheet with the smaller basis weight of each sample faced upward and the overall thickness of the samples became about 25 mm. The samples were compressed with a compression jig at a rate of 10 mm/min. The load (N) applied at a time 20 seconds after the samples were shrunk by 25% with respect to the thickness before the compression was measured. The load was divided by the surface area of the sample (2500 mm²) and the quotient was used as a measure of cushioning property.

TABLE 1
1st Thermoplastic resin foamed sheet

| | | |
|---|---|---|
| Expansion ratio of 1st foamed layer | | 3.3 |
| Thickness of 1st foamed layer | mm | 2.9 |
| Basis weight of 1st foamed layer | g/m² | 797 |
| Flexural rigidity of 1st foamed sheet | N/cm | 25 |
| Heat transmission coefficient of 1st | W/m²/K | 25 |
| foamed sheet | | |

2nd Thermoplastic resin foamed sheet

| | | |
|---|---|---|
| Expansion ratio of 2nd foamed layer | | 7 |
| Thickness of 2nd foamed layer | mm | 1.4 |
| Basis weight of 2nd foamed layer | g/m² | 184 |
| Flexural rigidity of 2nd foamed sheet | N/cm | 18 |
| Heat transmission coefficient of 2nd | W/m²/K | 42 |
| foamed sheet | | |

3rd Thermoplastic resin foamed sheet

| | | |
|---|---|---|
| Flexural rigidity of 3rd foamed sheet | N/cm | 40 |
| Heat transmission coefficient of 3rd | W/m²/K | 22 |
| foamed sheet | | |

Molded article

| | | | |
|---|---|---|---|
| Expansion ratio | Molded article | | 6.2 |
| | 1st Foamed layer | | 3.9 |
| | 2nd Foamed layer | | 22 |
| Thickness | Molded article | mm | 8.0 |
| | 1st Foamed layer | mm | 3.4 |
| | 2nd Foamed layer | mm | 4.4 |

| | | |
|---|---|---|
| Flexural rigidity | N/cm | 75 |
| Heat transmission coefficient | W/m²/K | 9 |
| Cushioning property | N/cm² | 0.2 |

What is claimed is:

1. A method for producing a thermoplastic resin foamed article by vacuum forming using a molding apparatus including a pair of molds each having a molding surface through which vacuum sucking can be conducted, the method comprising a step of, while holding a thermoplastic resin foamed sheet between the molds, vacuum sucking through the molding surfaces of the molds to shape the thermoplastic resin foamed sheet, wherein the thermoplastic resin foamed sheet to be subjected to vacuum forming having a first foamed layer having an expansion ratio Xa of from 2 to 20, a thickness Ta of from 2 to 20 mm and a basis weight Ra of from 600 to 3000 g/m² and a second foamed layer having an expansion ratio Xb of from 4 to 40, a thickness Tb of from 2 to 12 mm and a basis weight Rb of from 100 to 600 g/m² wherein Ra/Rb is from 2 to 30.

2. The method according to claim 1, wherein the molding apparatus further comprises a holding means for holding a thermoplastic resin foamed sheet at a predetermined position between the molding surfaces of the molds, and wherein the step of shaping the thermoplastic resin foamed sheet by vacuum forming comprises sub-steps defined below:
(1) heating a thermoplastic resin foamed sheet to soften it;
(2) supplying the thermoplastic resin foamed sheet softened in step (1) between the molds;
(3) while holding the softened thermoplastic resin foamed sheet with the holding means between the molds, closing the molds until a clearance between peripheral portions of the molding surfaces of the molds arrives at a predetermined value not greater than the softened thermoplastic resin foamed sheet;
(4) starting vacuum sucking through the molding surfaces of the molds at a point of time during a period from the arrival of the clearance between the peripheral portions of the molding surfaces of the molds at the thickness of the softened thermoplastic resin foamed sheet to the arrival of the clearance at the predetermined value defined in step (3);
(5) while continuing the vacuum sucking, shaping the sheet into a shape defined by the molding surfaces of the molds;
(6) a combination of stopping the vacuum sucking, opening the molds and removing the molded article.

3. The method according to claim 2, wherein step (5) comprises an operation of opening the molds until the thermoplastic resin foamed sheet comes to have a predetermined thickness greater than the thickness of the softened foamed sheet at the start of the step (3).
